(19) United States
(12) Patent Application Publication
(10) Pub. No.: US 2023/0315097 A1
(43) Pub. Date: Oct. 5, 2023

(54) DRIVER ASSISTANCE SYSTEM AND DRIVER ASSISTANCE METHOD

(71) Applicant: HL Klemove Corp., Incheon (KR)

(72) Inventor: Yeongho SON, Suwon-si (KR)

(73) Assignee: HL Klemove Corp., Incheon (KR)

(21) Appl. No.: 18/126,752

(22) Filed: Mar. 27, 2023

(30) Foreign Application Priority Data
Mar. 29, 2022 (KR) 10-2022-0039044

(51) Int. Cl. G05D 1/02; G01S 17/931; G01S 19/42; G06V 20/58; G08G 1/0969

(52) U.S. Cl. CPC G05D 1/021; G01S 17/931; G01S 19/42; G06V 20/582; G06V 20/584; G08G 1/0969

(57) ABSTRACT

Disclosed herein is a driver assistance system including a Global Navigation Satellite System (GNSS) module configured to acquire GNSS signals of a vehicle, a camera installed in the vehicle to have a forward field of view from the vehicle and configured to acquire front image data for the forward field of view from the vehicle, a light detection and ranging (LiDAR) device installed in the vehicle to have an external field of view of the vehicle and configured to acquire LiDAR data for the external field of view of the vehicle, and a controller including at least one processor configured to process data acquired by the GNSS, the camera, and the LiDAR device. The controller determines a position of the vehicle based on the GNSS signals, identifies a traffic structure near the vehicle based on the front image data, determines a relative position of the identified traffic structure based on LiDAR data about the identified traffic structure, and corrects the position of the vehicle position based on the relative position of the traffic structure.

### CROSS-REFERENCE TO RELATED APPLICATION

This application claims the benefit of Korean Patent Application No. 10-2022-0039044, filed on Mar. 29, 2022 in the Korean Intellectual Property Office, the disclosure of which is incorporated herein by reference.

### BACKGROUND

### 1. Field

Embodiments of the present disclosure relate to a driver assistance system capable of acquiring accurate positioning information of a vehicle, and a driver assistance method.

### 2. Description of the Related Art

In general, it is most important for autonomous vehicles to accurately identify their positions in order to drive themselves while recognizing surrounding traffic environments. In order to implement autonomous driving systems, it is essential to secure precise positioning technology.

Conventionally, light detection and ranging (LiDAR) map matching technology has been used to improve the accuracy of positioning information such as a position and a direction of a vehicle.

In LiDAR map matching technology, a point cloud map is generated, and then matching is performed. To do this, a large amount Fof data should be stored, and thus the LiDAR map matching technology is usable only in some demonstration sections and is difficult to use on general roads. In addition, it is difficult to acquire accurate positioning information when a terrain changes due to seasonal changes, construction, or the like.

### SUMMARY

Therefore, it is an aspect of the present disclosure to provide a driver assistance system and a driver assistance method in which accurate positioning information of the vehicle can be acquired by identifying a traffic structure positioned near an autonomous vehicle and matching the traffic structure with a position on a high definition (HD) map to correct a position of the vehicle, thereby implementing a precise autonomous driving system more simply and effectively.

Additional aspects of the disclosure will be set forth in part in the description which follows and, in part, will be obvious from the description, or may be learned by practice of the disclosure.

In accordance with one aspect of the present disclosure, a driver assistance system including a camera installed in a vehicle to have a forward field of view from the vehicle and configured to acquire front image data for the forward field of view from the vehicle, a light detection and ranging (LiDAR) device installed in the vehicle to have an external field of view of the vehicle and configured to acquire LiDAR data for the external field of view of the vehicle, and a controller including at least one processor configured to process data acquired by a Global Navigation Satellite System (GNSS) module, the camera, and the LiDAR device, wherein the GNSS module configured to acquire GNSS signals of the vehicle. The controller may determine a position of the vehicle based on the GNSS signals, identify a traffic structure near the vehicle based on the front image data, determine a relative position of the identified traffic structure based on LiDAR data about the identified traffic structure, and correct the position of the vehicle position based on the relative position of the traffic structure.

The controller may identify the traffic structure based on the front image data based on a position of the vehicle being within a preset region from the traffic structure on a high definition (HD) map.

The controller may correct the position of the vehicle by comparing a relative position of the traffic structure on the HD map with the relative position of the traffic structure based on the LiDAR data.

The controller may determine the relative position of the identified traffic structure based on the front image data, may acquire the LiDAR data about the identified traffic structure based on the relative position of the traffic structure based on the front image data, and may determine the relative position of the identified traffic structure based on the acquired LiDAR data.

The controller may correct the position of the vehicle to a position corresponding to the relative position of the traffic structure.

The position of the vehicle may include global coordinates. The relative position of the traffic structure may include local coordinates.

The traffic structure may include at least one of a road sign and a traffic light, and an HD map may include a map expressed down to a lane unit and information about a lane and the traffic structure.

The controller may identify the traffic structure near the vehicle based on the GNSS signals and behavior data acquired from a behavior sensor of the vehicle.

The controller may identify the traffic structure near the vehicle using machine learning based on the front image data.

The controller may set a region of interest of the traffic structure near the vehicle based on the front image data and may determine the relative position of the identified traffic structure based on LiDAR data in the region of interest.

In accordance with another aspect of the present disclosure, a driver assistance method including acquiring Global Navigation Satellite System (GNSS) signals of a vehicle, determining a position of the vehicle based on the GNSS signals, acquiring front image data of the vehicle, identifying a traffic structure near the vehicle based on the acquired front image data, acquiring LiDAR data about the identified traffic structure, determining a relative position of the identified traffic structure based on the acquired LiDAR data, and correcting the position of the vehicle based on the relative position of the traffic structure.

The identifying of the traffic structure near the vehicle may include identifying the traffic structure based on the front image data based on a position of the vehicle being within a preset region from the traffic structure on a high definition (HD) map.

The correcting of the position of the vehicle may include correcting the position of the vehicle by comparing a relative position of the traffic structure on the HD map with the relative position of the traffic structure based on the LiDAR data.

The acquiring of the LiDAR data about the identified traffic structure may include determining the relative position of the identified traffic structure based on the front image data, acquiring the LiDAR data about the identified traffic structure based on the relative position of the traffic structure based on the front image data, and determining the relative position of the identified traffic structure based on the acquired LiDAR data.

The correcting of the position of the vehicle may include correcting the position of the vehicle to a position corresponding to the relative position of the traffic structure.

The position of the vehicle may include global coordinates. The relative position of the traffic structure may include local coordinates.

The traffic structure may include at least one of a road sign and a traffic light, and an HD map may include a map expressed down to a lane unit and information about a lane and the traffic structure.

The determining of the position of the vehicle based on the acquired GNSS signals may include identifying the traffic structure near the vehicle based on the GNSS signals and behavior data acquired from a behavior sensor of the vehicle.

The identifying of the traffic structure near the vehicle based on the acquired front image data may include identifying the traffic structure near the vehicle using machine learning based on the front image data.

The determining of the relative position of the identified traffic structure based on the acquired LiDAR data may include setting a region of interest of the traffic structure near the vehicle based on the front image data, and determining the relative position of the identified traffic structure based on LiDAR data in the region of interest.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram of a driver assistance system according to an embodiment;

FIG. 2 is a control flowchart of a driver assistance method according to an embodiment;

FIG. 3 illustrates an exemplary representation of an image acquired by a camera of a driver assistance system according to an embodiment;

FIG. 4 illustrates identification of a traffic light in an image acquired by a camera of a driver assistance system and determination of a relative position of the traffic light according to an embodiment;

FIG. 5 illustrates determination of a relative position of a traffic light from LiDAR data acquired by a LiDAR device of a driver assistance system according to an embodiment; and

FIG. 6 illustrates correction of a position of a vehicle in a driver assistance system according to an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference will now be made in detail to the exemplary embodiments of the present disclosure, examples of which are illustrated in the accompanying drawings, wherein like reference numerals refer to like elements throughout.

The expression, “at least one of a, b, and c,” should be understood as including only a, only b, only c, both a and b, both a and c, both b and c, or all of a, b, and c.

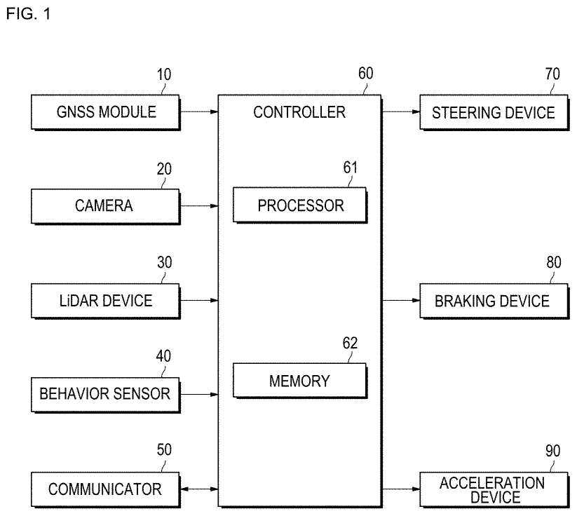

FIG. 1 is a control block diagram of a driver assistance system according to an embodiment.

Referring to FIG. 1, the driver assistance system may include a Global Navigation Satellite System (GNSS) module 10, a camera 20, a light detection and ranging (LiDAR) device 30, a behavior sensor 40, a communicator 50, and a controller 60.

The controller 60 may perform overall control of the driver assistance system.

The controller 60 may be electrically connected to the GNSS module 10, the camera 20, the LiDAR device 30, the behavior sensor 40, and the communicator 50.

The controller 60 may control a steering device 70, a braking device 80, and an acceleration device 90. Under the control of the controller 60, the steering device 70 may change a traveling direction of a vehicle. Under the control of the controller 60, the braking device 80 may decelerate the vehicle by braking wheels of the vehicle. Under the control of the controller 60, the acceleration device 90 may decelerate the vehicle by driving an engine and/or a driving motor that provides a driving force to the vehicle. The controller 60 may be electrically connected to other electronic devices of the vehicle to control the other electronic devices.

The GNSS module 10 may be a positioning information module for acquiring positioning information of the vehicle and may receive, for example, GNSS signals including navigation data from one or more GNSS satellites. The vehicle may acquire a position and a traveling direction of the vehicle based on the GNSS signals.

The camera 20 may be installed in the vehicle to have a forward field of view from the vehicle and may photograph a view in front of the vehicle to acquire front image data of the vehicle. The front image data may include front image data of the vehicle captured through the camera 20, but the present disclosure is not limited thereto. Side image data and rear image data may also be included.

The camera 20 may identify traffic facilities (traffic lights, road signs, and the like) that are road facilities around a road in front of the vehicle.

The camera 20 may include a plurality of lenses and an image sensor. The image sensor may include a plurality of photodiodes that convert light into an electrical signal, and the plurality of photodiodes may be disposed in the form of a two-dimensional matrix.

The camera 20 may transmit the image data of the view in front of the vehicle 1 to the controller 60.

The LiDAR device 30 may obtain relative positions, relative speeds, and the like with respect to moving objects such as other vehicles, pedestrians, and cyclists around the vehicle. In addition, the LiDAR device 30 may obtain shapes and relative positions of fixed objects (for example, traffic structures such as traffic lights and road signs) around the vehicle.

The LiDAR device 30 may be installed in the vehicle to have an external field of view of the vehicle and may acquire LiDAR data for the external field of view of the vehicle. The LiDAR data may be data including images of fixed objects and moving objects in the external field of view of the vehicle.

The behavior sensor 40 may acquire behavior data of the vehicle. For example, the behavior sensor 40 may include a speed sensor for detecting a wheel speed, an acceleration sensor for detecting lateral acceleration and longitudinal acceleration of the vehicle, a yaw rate sensor for detecting a yaw rate of the vehicle, a gyro sensor for detecting an inclination of the vehicle, a steering angle sensor for detecting a rotation angle and a steering angle of a steering wheel, and/or a torque sensor for detecting steering torque of the steering wheel. The behavior data may include a speed, lateral acceleration, longitudinal acceleration, a yaw rate, a vehicle inclination, a steering angle, and/or steering torque of the vehicle.

The communicator 50 may communicate with a server to receive a high definition map (hereinafter referred to as an HD map) and positioning information of the vehicle from the server in real time. In this case, the HD map is a map expressed down to a lane unit in detail and includes lanes including center lines and boundary lines and road facilities including traffic lights, road signs, and road surface marks.

The communicator 50 may include one or more components enabling communication with an external device and may include, for example, a wireless Internet module, a short-range communication module, an optical communication module, and the like. The wireless Internet module may be a module for wireless Internet access and may be internally or externally coupled to the vehicle. The wireless Internet module may be configured to transmit and receive wireless signals through communication networks according to wireless Internet technologies. The wireless Internet technologies may include, for example, wireless LAN (WLAN), wireless-fidelity (Wi-Fi), Wi-Fi direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-Advanced (LTE-A), 5G networks, and 6G networks. The short-range communication module may be for short-range communication and may support short-range communication using at least one of Bluetooth™, radio frequency identification (RFID), Infrared Data Association (IrDA), ultra wideband (UWB), ZigBee, near field communication (NFC), Wi-Fi, Wi-Fi direct, and wireless Universal Serial Bus (USB) technologies. The optical communication module may include an optical transmitter and an optical receiver.

The communicator 50 may receive an HD map and positioning information through vehicle-to-vehicle (V2V) wireless communication or receive an HD map and positioning information through wireless communication (vehicle to everything (V2X) wireless communication) with a server.

Each of the GNSS module 10, the camera 20, the LiDAR device 30, the behavior sensor 40, and the communicator 50 may include a controller (electronic control unit (ECU)). The controller 60 may be implemented as an integrated controller including the controller of the GNSS module 10, the controller of the camera 20, the controller of the LiDAR device 30, the controller of the behavior sensor 40, and the controller of the communicator 50.

The controller 60 may include a processor 61 and a memory 62.

The controller 60 may include one or more processors 61. One or more processors 61 included in the controller 60 may be integrated into one chip or may be physically separated. Alternatively, the processor 61 and the memory 62 may each be implemented as a single chip.

The processor 61 may process GNSS signals acquired by the GNSS module 10, front image data acquired by the camera 20, LiDAR data acquired by the LiDAR device 30, HD map data, and the like. In addition, the processor 51 may generate control signals for autonomous driving of the vehicle, such as a steering signal for controlling the steering device 70, a braking signal for controlling the braking device 80, and an acceleration signal for controlling the acceleration device 90.

For example, the processor 61 may include an analog signal/digital signal processor for processing GNSS signals acquired by the GNSS module 10, may include an image signal processor for processing front image data of the camera 20, may include a digital signal processor for processing LiDAR data of the LiDAR device 30, and may include a micro control unit (MCU) for generating a steering signal, a braking signal, and an acceleration signal.

The memory 62 may store programs and/or data for the processor 61 to process front image data. The memory 62 may store programs and/or data for the processor 61 to process LiDAR data. In addition, the memory 62 may store programs and/or data for the processor 61 to generate control signals related to components of the vehicle. Furthermore, the memory 62 may store HD map data provided from the server. The memory 62 may temporarily store data received from the GNSS module 10, the camera 20, and the LiDAR device 30. In addition, the memory 62 may temporarily store results obtained by the processor 61 processing the GNSS signals, the front image data, and the LiDAR data. The memory 62 may include not only volatile memories such as a static random access memory (SRAM) and a dynamic random access memory (DRAM) but also non-volatile memories such as a flash memory, a read only memory (ROM), and an erasable programmable read only memory (EPROM), and the like.

The controller 60 having such a configuration determines an approximate position of the vehicle using GNSS signals, behavior data, and an HD map, determines an approximate relative position of a traffic structure by identifying the traffic structure using the camera 20 in a region adjacent to the traffic structure, determines an exact relative position of the traffic structure using the LiDAR device, and corrects the approximate position of the vehicle to an accurate position using the exact relative position of the traffic structure. Therefore, according to the driver assistance system according to the embodiment, by using a position of a traffic structure and the characteristics of the traffic structure of a relatively low-capacity HD map instead of a LiDAR point cloud map, it is possible to acquire accurate positioning information of the vehicle and to solve problems of incorrect map matching due to seasonal changes, road construction, or the like, making it possible to implement a precise autonomous driving system more simply and effectively.

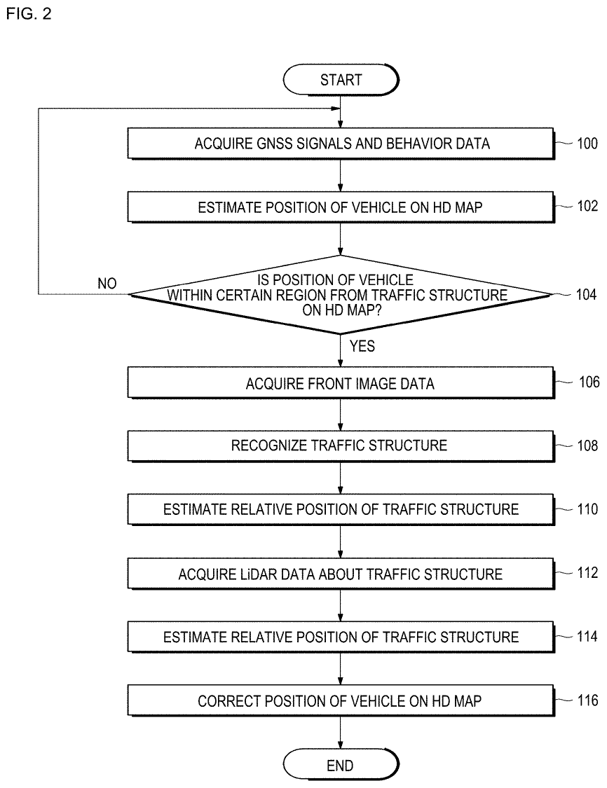

FIG. 2 is a control flowchart of a driver assistance method according to an embodiment.

Referring to FIG. 2, first, a controller 60 acquires GNSS signals of a vehicle through a GNSS module 10 and acquires behavior data of the vehicle through a behavior sensor 40 (100).

The controller 60 determines a position of the vehicle on an HD map by matching the GNSS signals and the behavior data of the vehicle to the HD map stored in a memory 62 (102). The position of the vehicle on the HD map may be at global coordinates. In this case, the position of the vehicle on the HD map may be determined by matching only the GNSS signals of the vehicle to the HD map stored in the memory 62.

Based on the position of the vehicle on the HD map and a position of a traffic structure on the HD map, the controller 60 determines whether the position of the vehicle is within a certain region from the traffic structure (104). That is, the controller 60 determines whether the vehicle is close to the traffic structure.

As a result of determination in operation mode 104, when the position of the vehicle on the HD map is outside the certain region from the traffic structure in a traveling direction, the controller 60 returns to operation mode 100 and performs the following operation modes.

As a result of determination in operation mode 104, when the position of the vehicle on the HD map is within the certain region from the traffic structure in the traveling direction, the controller 60 acquires front image data by photographing a view in front of the vehicle through a camera 20 (106).

The controller 60 analyzes the front image data to identify the traffic structure in a front image (108).

The controller 60 determines a relative position of the identified traffic structure (110). The controller 60 may determine a relatively approximate relative position of the identified traffic structure. When the relative position of the traffic structure is determined based on the front image data acquired by the camera 20, since the relative position of the traffic structure is determined through image analysis, the accuracy of the determination is lower as compared with a method using a LiDAR device 30 capable of directly measuring a relative position.

The controller 60 acquires LiDAR data about a region in which the traffic structure is positioned through the LiDAR device 30 based on the relative position of the identified traffic structure (112).

The controller 60 determines the relative position of the identified traffic structure based on the acquired LiDAR data (114). The controller 60 may determine a relatively accurate relative position of the identified traffic structure. When the relative position of the traffic structure is determined based on the LiDAR data acquired by the LiDAR device 30, the accuracy of the determination is relatively higher as compared with a method using the camera 20.

The controller 60 corrects the position of the vehicle on the HD map determined in operation mode 102 based on the relative position of the traffic structure determined in operation mode 114 (116). The position of the vehicle on the HD map determined in operation mode 102 is corrected to a position corresponding to the relative position of the traffic structure determined in operation mode 114.

As described above, according to the driver assistance system according to the embodiment, the position of the vehicle can be corrected through a method of matching the relative position of the traffic structure on the road recognized using the camera 20 provided in the vehicle with the relative position of the traffic structure on the HD map, thereby improving positioning performance of the vehicle.

Sizes and heights of traffic structures such as road signs and traffic lights are standardized and thus can be identified with sensors installed in a vehicle without much difficulty.

The characteristics of a traffic structure can be identified through the camera 20, and a distance can be measured more accurately using the LiDAR device 30, thereby enabling positioning correction of the vehicle.

Through a method using a position of a traffic structure and the characteristics of the traffic structure on an HD map without using a LiDAR point cloud map as in the related art, it is possible to perform accurate positioning correction using a low-capacity map, and it is possible to solve a problem of incorrect map matching due to seasonal changes, road construction, or the like.

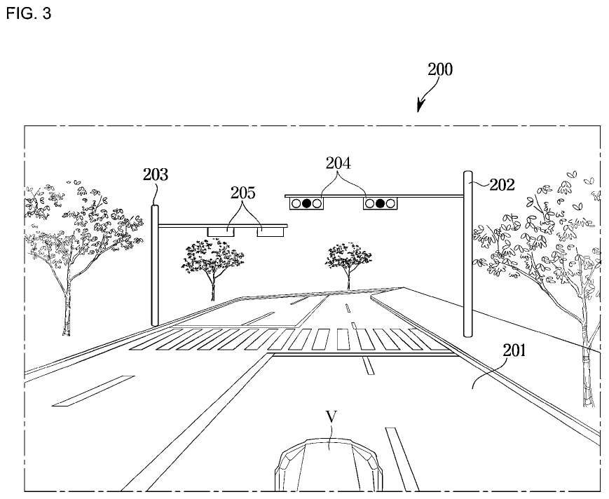

FIG. 3 illustrates an exemplary representation of an image acquired by a camera of a driver assistance system according to an embodiment.

Referring to FIG. 3, a front image frame 200 is exemplarily shown in front image data captured by a camera 20 while a vehicle V is traveling.

The front image frame 200 includes an environment around the vehicle, such as a road 201, traffic light poles 202 and 203, traffic lights 204 and 205, and a building 206.

The front image frame 200 is a frame of front image data acquired using the camera 20 while the vehicle V is traveling along the road 201.

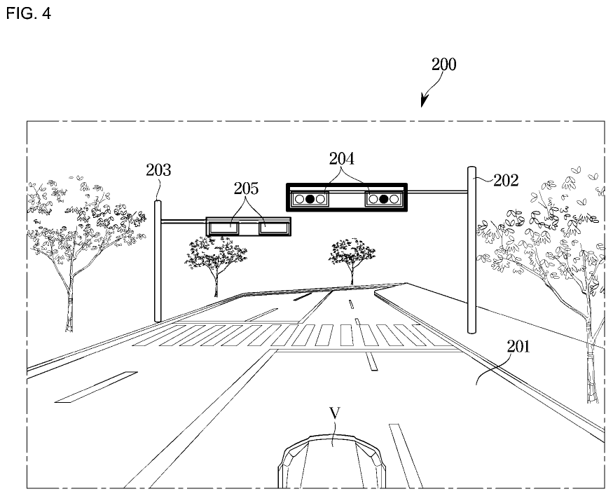

FIG. 4 illustrates identification of a traffic light in an image acquired by a camera of a driver assistance system and determination of a relative position of the traffic light according to an embodiment.

Referring to FIG. 4, traffic lights 202 and 203 may be identified in a front image frame 200. For example, an object may be identified through image processing such as receiving red-green-blue (RGB) information of the front image frame 200 and detecting an outline, and the characteristics of the identified object may be compared with the characteristics of a traffic light to find the traffic light and determine a relative distance of the found traffic light.

The traffic lights 202 and 203 may be identified by analyzing the front image frame 200 through a machine learning method. Machine learning may be learning using a model composed of a plurality of parameters to optimize the parameters with given data. The machine learning may include supervised learning, unsupervised learning, and reinforcement learning according to the form of a learning problem. The supervised learning may be learning mapping between an input and an output and may be applied when a pair of an input and an output is given as data. The unsupervised learning may be applied when there are only inputs and no output, and regularity between the inputs may be found. Traffic lights 204 and 205 may be identified not only through the machine learning but also through a deep learning method, and the traffic lights 204 and 205 may be identified in various ways.

Among a plurality of traffic lights present in a traveling direction, a traffic light from which a position of a vehicle V is within a certain region (for example, 204) is identified on an HD map, and a relative position of the traffic light 204 with respect to the vehicle V is determined in the front image frame 200.

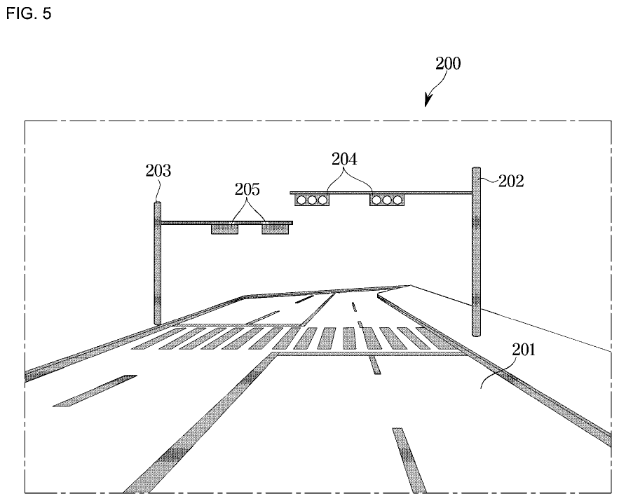

FIG. 5 illustrates determination of a relative position of a traffic light from LiDAR data acquired by a LiDAR device of a driver assistance system according to an embodiment.

Referring to FIG. 5, based on a traffic light 204 identified through a camera 20 and a relative position of the traffic light 204, LiDAR data about a region in which the traffic light 204 is positioned is acquired through a LiDAR device 30.

The region in which the traffic light 204 is positioned when a vehicle V travels along a road is specified as a region of interest to acquire the LiDAR data, and then the LiDAR data is analyzed to extract the traffic light 204 based on the characteristics of the traffic light 204 identified through the camera 20 and to determine the relative position of the extracted traffic light 204.

In general, by using the straightness of laser light, the LiDAR device 30 measures a medium and a relative position of an object using a time for light emitted from the LiDAR device 30 to be reflected and returned from the object, and intensity of returned light. In technology that uses light with high straightness, each measurement is expressed as a point, and a result thereof is visualized as a localized point cloud. Collected point cloud data has an advantage in that an outline of an object is expressed well and a relative position is accurate but has a disadvantage in that an amount of information of raw data is enormous, which not only causes a high computational load but also requires various preprocessing processes because a boundary of an object cannot be specified only with the raw data.

However, since LiDAR data is acquired by specifying a region in which the traffic light 204 identified through the camera 20 is positioned as a region of interest, an amount of unnecessary data can be reduced, thereby extracting a shape of a point cloud and a cluster corresponding to the traffic light, which is an object of interest, with a relatively small computational load.

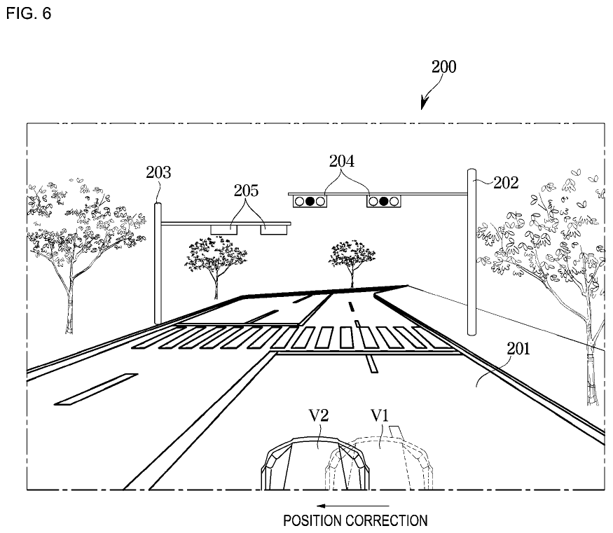

FIG. 6 illustrates correction of a position of a vehicle in a driver assistance system according to an embodiment.

Referring to FIG. 6, based on a relative position of a traffic light 204 determined using a LiDAR device 30, a position of the vehicle based on a GNSS module 10 is corrected on an HD map.

Since a relative position (local coordinates) of the traffic light 204 based on the LiDAR device 30 and a position (global coordinates) of the vehicle based on the GNSS module 10 are known, and a relative position of the traffic light 204 with respect to the position of the vehicle on the HD map is known, through a method of comparing the relative positions of the same traffic lights 204, a position V1 of the vehicle based on the GNSS module 10 may be corrected to a position V2 corresponding to the relative position of the traffic light 204 based on the LiDAR device 30.

As described above, according to the present disclosure, a position of a vehicle is corrected through a method of matching a relative position of a traffic structure on a road recognized using a camera provided in a vehicle with a relative position of a traffic structure on an HD map. Therefore, according to the present disclosure, through a method using a position of a traffic structure and the characteristics of the traffic structure on an HD map without using a LiDAR point cloud map as in a related art, it is possible to perform accurate positioning correction using a low-capacity map, and it is possible to solve a problem of incorrect map matching due to seasonal changes, road construction, or the like.

According to the present disclosure, since a traffic structure positioned near an autonomous vehicle is identified and matched with a position on an HD map to correct a position of the vehicle, accurate positioning information of the vehicle can be acquired, thereby implementing a precise autonomous driving system more simply and effectively.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A driver assistance system comprising:
a camera installed in a vehicle to have a forward field of view from the vehicle and configured to acquire front image data for the forward field of view from the vehicle;
a light detection and ranging (LiDAR) device installed in the vehicle to have an external field of view of the vehicle and configured to acquire LiDAR data for the external field of view of the vehicle; and
a controller including at least one processor configured to process data acquired by a Global Navigation Satellite System (GNSS) module, the camera, and the LiDAR device, the GNSS module being configured to acquire GNSS signals of the vehicle,
wherein the controller is configured to:
determine a position of the vehicle based on the GNSS signals,
identify a traffic structure near the vehicle based on the front image data,
determine a relative position of the identified traffic structure based on LiDAR data about the identified traffic structure, and
correct the position of the vehicle position based on the relative position of the traffic structure.

2. The driver assistance system of claim 1, wherein the controller is configured to identify the traffic structure based on the front image data based on a position of the vehicle being within a preset region from the traffic structure on a high definition (HD) map.

3. The driver assistance system of claim 2, wherein the controller is configured to correct the position of the vehicle by comparing a relative position of the traffic structure on the HD map with the relative position of the traffic structure based on the LiDAR data.

4. The driver assistance system of claim 1, wherein the controller is configured to:
determine the relative position of the identified traffic structure based on the front image data,
acquire the LiDAR data about the identified traffic structure based on the relative position of the traffic structure based on the front image data, and
determine the relative position of the identified traffic structure based on the acquired LiDAR data.

5. The driver assistance system of claim 1, wherein the controller is configured to correct the position of the vehicle to a position corresponding to the relative position of the traffic structure.

6. The driver assistance system of claim 1, wherein:
the position of the vehicle includes global coordinates; and
the relative position of the traffic structure includes local coordinates.

7. The driver assistance system of claim 1, wherein:
the traffic structure includes at least one of a road sign and a traffic light; and
an high definition (HD) map comprises a map expressed down to a lane unit and information about a lane and the traffic structure.

8. The driver assistance system of claim 1, wherein the controller is configured to identify the traffic structure near the vehicle based on the GNSS signals and behavior data acquired from a behavior sensor of the vehicle.

9. The driver assistance system of claim 1, wherein the controller is configured to identify the traffic structure near the vehicle using machine learning based on the front image data.

10. The driver assistance system of claim 1, wherein the controller is configured to:
set a region of interest of the traffic structure near the vehicle based on the front image data and
determine the relative position of the identified traffic structure based on LiDAR data in the region of interest.

11. A driver assistance method comprising:
acquiring Global Navigation Satellite System (GNSS) signals of a vehicle;
determining a position of the vehicle based on the GNSS signals;
acquiring front image data of the vehicle;
identifying a traffic structure near the vehicle based on the acquired front image data;
acquiring light detection and ranging (LiDAR) data about the identified traffic structure;
determining a relative position of the identified traffic structure based on the acquired LiDAR data; and
correcting the position of the vehicle based on the relative position of the traffic structure.

12. The driver assistance method of claim 11, wherein the identifying of the traffic structure near the vehicle comprises identifying the traffic structure based on the front image data based on a position of the vehicle being within a preset region from the traffic structure on a high definition (HD) map.

13. The driver assistance method of claim 12, wherein the correcting of the position of the vehicle comprises correcting the position of the vehicle by comparing a relative position of the traffic structure on the HD map with the relative position of the traffic structure based on the LiDAR data.

14. The driver assistance method of claim 11, wherein the acquiring of the LiDAR data about the identified traffic structure comprises:
determining the relative position of the identified traffic structure based on the front image data;
acquiring the LiDAR data about the identified traffic structure based on the relative position of the traffic structure based on the front image data; and
determining the relative position of the identified traffic structure based on the acquired LiDAR data.

15. The driver assistance method of claim 11, wherein the correcting of the position of the vehicle comprises correcting the position of the vehicle to a position corresponding to the relative position of the traffic structure.

16. The driver assistance method of claim 11, wherein:
the position of the vehicle includes global coordinates; and
the relative position of the traffic structure includes local coordinates.

17. The driver assistance method of claim 11, wherein:
the traffic structure includes at least one of a road sign and a traffic light; and
an high definition (HD) map comprises a map expressed down to a lane unit and information about a lane and the traffic structure.

18. The driver assistance method of claim 11, wherein the determining of the position of the vehicle based on the acquired GNSS signals comprises identifying the traffic structure near the vehicle based on the GNSS signals and behavior data acquired from a behavior sensor of the vehicle.

19. The driver assistance method of claim 11, wherein the identifying of the traffic structure near the vehicle based on the acquired front image data comprises identifying the traffic structure near the vehicle using machine learning based on the front image data.

20. The driver assistance method of claim 11, wherein the determining of the relative position of the identified traffic structure based on the acquired LiDAR data comprises:
setting a region of interest of the traffic structure near the vehicle based on the front image data; and
determining the relative position of the identified traffic structure based on LiDAR data in the region of interest.
